(19) United States
(12) Patent Application Publication
(10) Pub. No.: US 2021/0067872 A1
(43) Pub. Date: Mar. 4, 2021

(54) Information Processing Apparatus And Computer-Readable Recording Medium

(71) Applicant: FUJITSU CLIENT COMPUTING LIMITED, Kawasaki-Shi (JP)

(72) Inventor: Sho UCHIDA, Kanagawa (JP)

(21) Appl. No.: 16/927,046

(22) Filed: Jul. 13, 2020

(30) Foreign Application Priority Data
Aug. 27, 2019 (JP) 2019-154993

(51) Int. Cl. H04R 3/00; H04R 5/04; G10L 25/78; G06T 7/70

(52) U.S. Cl. CPC H04R 3/005; H04R 5/04; G06T 2207/30196; G06T 7/70; G10L 2025/783; G10L 25/78

(57) ABSTRACT

Microphones convert sound into audio signals. A sensor detects the presence and position of one or more human bodies. Then, the sensor outputs sensor data representing one or more directions in which the human bodies are present. An information processing apparatus determines an enhancement direction based on the one or more directions indicated by the sensor data. Then, the information processing apparatus generates a synthesized audio signal where sound coming from the enhancement direction is enhanced, based on the audio signals acquired from the microphones.

### CROSS-REFERENCE TO RELATED APPLICATION

This application is based upon and claims the benefit of priority of the prior Japanese Patent Application No. 2019-154993, filed on Aug. 27, 2019, the entire contents of which are incorporated herein by reference.

### FIELD

The embodiments discussed herein are related to an information processing apparatus and non-transitory computer-readable recording medium storing therein a computer program.

### BACKGROUND

Personal computers (PCs) with microphones have become widely used. A technique of acquiring user's voice with reduced noise using microphones is known as beamforming.

In beamforming, a plurality of audio signals captured by a plurality of omnidirectional microphones is synthesized and the sound coming from a particular direction is enhanced. For example, in a videophone system, the setting for enhancing the sound coming from the front direction of a PC screen may be provided to increase the clarity of the voice of the user in front of the screen.

As for technology related to beamforming, there is, for example, a proposed voice arrival direction estimating and beamforming system for estimating in real time the arrival direction of the voice emitted from a moving sound source and at the same time implementing beamforming on the voice in real time.

See, for example, Japanese Laid-open Patent Publication No. 2008-175733.

In recent years, a voice assistant is built-in to PCs, which operates the PC according to spoken words of the user. The user is able to operate the PC by speaking to the voice assistant without being in front of the screen.

However, in beamforming on a PC, the setting for enhancing the sound coming from the front direction of the screen may be implemented on the assumption that the user is in front of the screen. In this case, the accuracy of speech recognition of the user's voice is reduced except when the user is in front of the screen.

Note that, like the aforementioned voice arrival direction estimating and beamforming system, it is possible to estimate in real time the arrival direction of the voice emitted from a moving sound source. This technique, however, estimates the sound arrival direction, resting on the premise that the voice is emitted from the moving sound source, and is therefore poor in estimating the direction of the user before speaking and after he/she has moved silently and largely. If the system fails to estimate the direction of the user, beamforming provides insufficient accuracy in speech recognition.

### SUMMARY

According to an aspect, there is provided an information processing apparatus including: a plurality of microphones configured to convert sound into audio signals; a sensor configured to detect presence and position of one or more human bodies and output sensor data representing one or more directions in which the one or more human bodies are present; and a processor configured to execute a process including determining an enhancement direction based on the one or more directions indicated by the sensor data acquired from the sensor, and generating a synthesized audio signal where sound coming from the enhancement direction is enhanced, based on the audio signals acquired from the plurality of microphones.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary information processor according to a first embodiment;

FIG. 2 illustrates an overview of a second embodiment;

FIG. 3 illustrates an exemplary hardware configuration of a user terminal;

FIG. 4 illustrates an exemplary monitor configuration;

FIG. 5 is a block diagram illustrating exemplary functions of the user terminal;

FIG. 6 illustrates exemplary sound transmission;

FIG. 7 illustrates an exemplary method of outputting position coordinates of human bodies by a sensor;

FIG. 8 is an exemplary method of determining an enhancement direction;

FIG. 9 illustrates exemplary installation position information;

FIG. 10 is a flowchart illustrating exemplary procedure of first enhancement direction control;

FIG. 11 is a flowchart illustrating exemplary procedure of first synthesized audio signal generation;

FIG. 12 illustrates an outline of a third embodiment;

FIG. 13 is a block diagram illustrating another example of functions of the user terminal;

FIG. 14 illustrates an exemplary method of calculating a sound source direction;

FIG. 15 is a flowchart illustrating exemplary procedure of second enhancement direction control;

FIG. 16 illustrates an outline of a fourth embodiment;

FIG. 17 is a flowchart illustrating exemplary procedure of third enhancement direction control;

FIG. 18 is a flowchart illustrating exemplary procedure of second synthesized audio signal generation; and

FIG. 19 illustrates an exemplary system configuration according to another embodiment.

### DESCRIPTION OF EMBODIMENTS

Several embodiments will be described below with reference to the accompanying drawings. These embodiments may be combined with each other unless they have contradictory features.

### (a) First Embodiment

The description begins with a first embodiment.

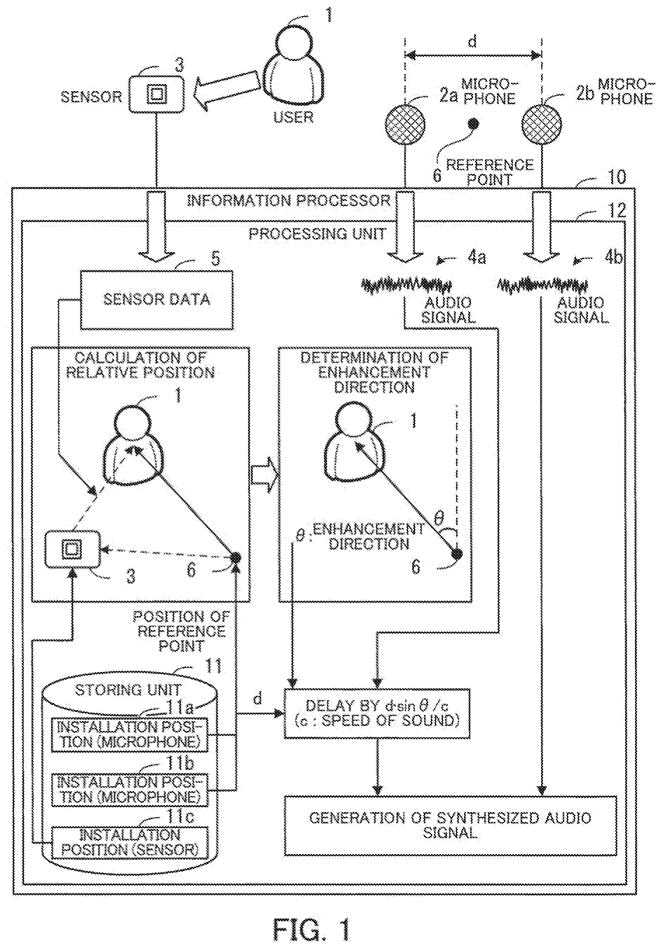

FIG. 1 illustrates an exemplary information processor according to the first embodiment. In the example of FIG. 1, an information processor 10 implements, in capturing sound, a setting that provides directionality to the sound coming from the direction of user 1. The information processor 10 is able to implement directionality setting processing by executing a program that describes a sequence of procedures for setting directionality.

The information processor 10 is connected to microphones 2a and 2b and a sensor 3. The microphones 2a and 2b are, for example, omnidirectional microphones. The microphone 2a converts sound into an audio signal 4a. The microphone 2b converts sound into an audio signal 4b.

The sensor 3 is used to detect the presence and position of one or more human bodies. The sensor 3 outputs sensor data representing one or more directions in each of which a human body is present. In the following example, the sensor 3 outputs sensor data 5 representing the direction in which a single human body is present (i.e., the direction of the user 1). The sensor data 5 includes a first relative position which indicates the position of the user 1 relative to the sensor 3.

The information processor 10 includes a storing unit 11 and a processing unit 12. The storing unit 11 is, for example, a memory or storage device provided in the information processor 10. The processing unit 12 is, for example, a processor or operation circuit provided in the information processor 10.

The storing unit 11 stores therein installation positions 11a, 11b, and 11c. The installation position 11a represents the position where the microphone 2a is installed. The installation position 11b represents the position where the microphone 2b is installed. The installation position 11c represents the position where the sensor 3 is installed.

The processing unit 12 determines the enhancement direction based on the direction where the user 1 is present. For example, the processing unit 12 determines the direction of the user 1 as the enhancement direction. In this case, the processing unit 12 calculates, as the direction of the user 1, the direction of the user 1 relative to a predetermined reference point.

For example, the processing unit 12 calculates a second relative position which indicates the position of the user 1 relative to a reference point 6 defined based on the installation positions 11a and 11b. The reference point 6 is, for example, a midpoint of the microphones 2a and 2b. The processing unit 12 calculates the midpoint of the installation positions 11a and 11b as the position of the reference point 6. Based on the position of the reference point 6 and the installation position 11c, the processing unit 12 calculates the position of the sensor 3 relative to the reference point 6. Then, the processing unit 12 adds the position of the user 1 relative to the sensor 3, included in the sensor data 5, and the position of the sensor 3 relative to the reference point 6 to thereby calculate the position of the user 1 relative to the reference point 6 (the second relative position).

Then, the processing unit 12 calculates, as the direction of the user 1, a direction from the reference point 6 to the second relative position. The direction of the user 1 calculated here is represented by an angle θ formed in a horizontal plane by a line through the reference point 6 perpendicular to a line connecting the microphones 2a and 2b and a line connecting the reference point 6 and the second relative position. The processing unit 12 sets the enhancement direction to θ.

Based on the audio signals 4a and 4b acquired from the microphones 2a and 2b, the processing unit 12 generates a synthesized audio signal where the sound coming from the enhancement direction θ is enhanced. For example, the processing unit 12 delays, by d·sin θ/c, the audio signal 4a acquired from the microphone 2a closer to the user 1 out of the microphones 2a and 2b. Note that d is the distance between the microphones 2a and 2b and c is the speed of sound. Next, the processing unit 12 synthesizes the delayed audio signal 4a and the audio signal 4b, to thereby generate the synthesized audio signal. Here is the reason why the sound coming from the enhancement direction θ is enhanced in the synthesized audio signal thus generated.

A plane wave representing the sound coming from the enhancement direction θ reaches the microphone 2a earlier than the microphone 2b by d·sin θ/c. Therefore, the sound coming from the enhancement direction θ, included in the audio signal 4a delayed by d·sin θ/c, is in phase with the sound coming from the enhancement direction θ, included in the audio signal 4b. On the other hand, the sound coming from a direction other than the enhancement direction θ (e.g. a direction θ′), included in the audio signal 4a delayed by d·sin θ/c, is out of phase with the sound coming from the direction θ′, included in the audio signal 4b. Hence, the delayed audio signal 4a and the audio signal 4b are synthesized to generate a synthesized audio signal where the sound coming from the enhancement direction θ is more enhanced than sounds coming from directions other than θ.

According to the information processor 10 described above, the synthesized audio signal is generated, where the sound coming from the direction of the user 1 is enhanced. That is, the voice of the user 1 is enhanced in the generated synthesized audio signal, which provides greater accuracy in speech recognition. In addition, the enhancement direction is set according to the direction of the user 1, which improves the accuracy of speech recognition even if the user 1 is not in front of the screen. Note that the direction of the user 1 relative to the reference point 6 is calculated as the direction of the user 1. This improves the accuracy of setting the enhancement direction. Further, because the direction of the user 1 is acquired from the sensor 3, the information processor 10 is able to set the enhancement direction before the user 1 starts speaking.

Note that the sensor data 5 may represent a plurality of directions, in each of which a human body is present. For example, the sensor data 5 may include a plurality of first relative positions representing the positions of a plurality of human bodies relative to the sensor 3. In addition, as the multiple directions of the human bodies, directions from the reference point 6 to a plurality of second relative positions may be calculated. In this case, the processing unit 12 calculates the second relative positions, which represent the positions of the multiple human bodies relative to the reference point 6, based on the installation positions 11a, 11b, and 11c and the first relative positions. Then, the processing unit 12 calculates the directions from the reference point 6 to the second relative positions as the directions of the human bodies. The processing unit 12 determines the enhancement direction based on the multiple directions of the human bodies.

For example, the processing unit 12 determines one of the directions of the human bodies as the enhancement direction. In this case, the processing unit 12 may acquire the direction in which a predetermined word or phrase has been spoken and determine, amongst the directions of the human bodies represented by the sensor data 5, one direction closest to the direction of the predetermined word or phrase spoken as the enhancement direction. The predetermined word or phrase here is, for example, a wake word used to activate a voice assistant. Therefore, a direction in which, amongst the multiple human bodies detected by the sensor 3, the user of the voice assistant is present is determined as the enhancement direction. This provides greater accuracy in speech recognition of the voice assistant.

In addition, for example, the processing unit 12 may determine the multiple directions of the human bodies represented by the sensor data 5 as individual enhancement directions and generate a plurality of synthesized audio signals in each of which the sound coming from the corresponding enhancement direction is enhanced. Assume here that one of the multiple users detected by the sensor is providing audio input. In this case, the multiple synthesized audio signals include a synthesized audio signal which has been generated with the direction of the user providing the audio input determined as the enhancement direction. Therefore, speech recognition processing is performed on each of the generated synthesized audio signals, thus providing improved accuracy in speech recognition of one or another of the synthesized audio signals.

In addition, the sensor data 5 may include distance information indicating the distance of each of one or more human bodies from the sensor 3. In this case, if any of the distances of the individual human bodies from the sensor 3 is greater than or equal to a threshold, the processing unit 12 may increase sensitivity of the microphones 2a and 2b. This makes it easier for the microphones 2a and 2b to convert the voice of the user at far distance into audio signals.

Further, the information processor 10 may be provided with a display unit, and the microphones 2a and 2b may be installed in a plane parallel to the display surface of the display unit. This improves the accuracy of speech recognition even if the installation positions of the microphones 2a and 2b are limited to the plane parallel to the display surface.

### (b) Second Embodiment

Next, a second embodiment is described. The second embodiment is directed to set a direction in which directionality of beamforming is given, according to the user's position.

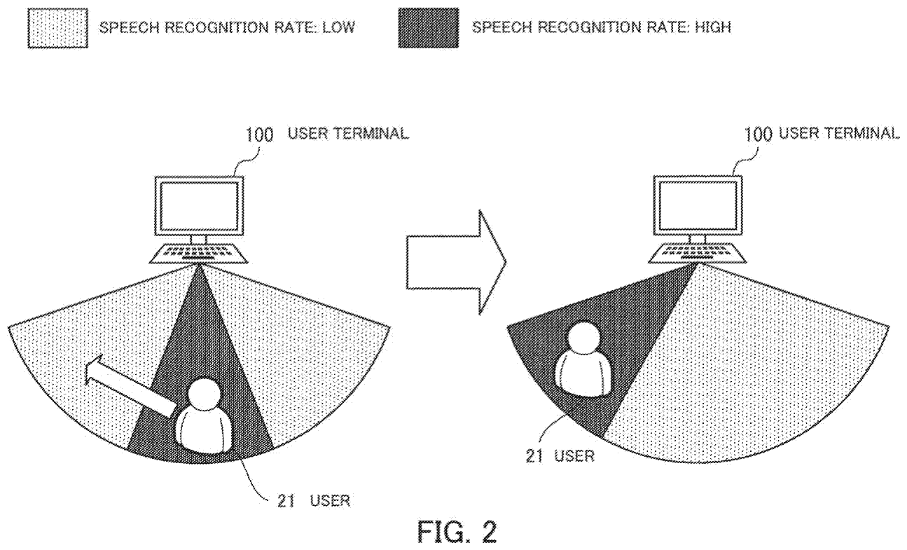

FIG. 2 illustrates an overview of the second embodiment. A user terminal 100 is a terminal activated by voice (voice-activated terminal) with the use of voice assistant software or similar software. Upon acquiring an audio signal, the voice assistant software of the user terminal 100 performs processing according to words represented by the acquired audio signal. Based on the acquired audio signal, the words represented by the audio signal is sometimes estimated by speech recognition.

User 21 operates the user terminal 100 by voice. The user terminal 100 detects the user 21 using a sensor, and implements beamforming such that directionality is given in the direction where the user 21 is present (that is, the direction where a human body is present).

For example, in the case where the user 21 is in front of the user terminal 100, the user terminal 100 implements beamforming such that directionality to sound is given in the front direction. This achieves a high speech recognition rate for the sound coming from the front of the user terminal 100 while reducing a speech recognition rate for sounds coming from other directions.

In addition, for example, in the case where the user 21 has moved away in a direction other than the front direction, the user terminal 100 implements beamforming such that directionality to sound is given in the direction where the user 21 is present. This achieves a high speech recognition rate for the sound coming from the direction of the user 21 while reducing a speech recognition rate for sounds coming from other directions.

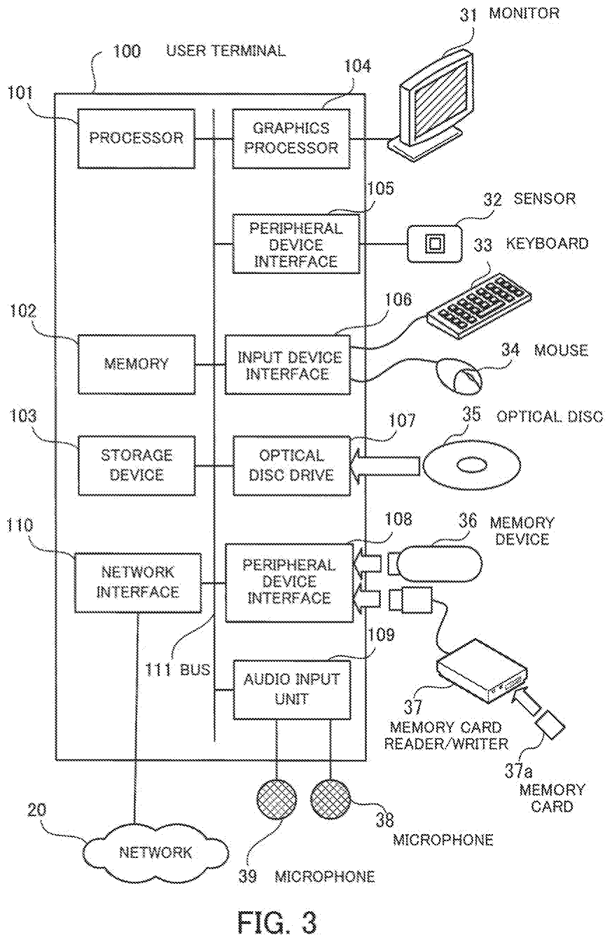

FIG. 3 illustrates an exemplary hardware configuration of a user terminal. The illustrated user terminal 100 has a processor 101 to control its entire operation. The processor 101 is connected to a memory 102 and other various devices and interfaces via a bus 111. The processor 101 may be a single processing device or a multiprocessor system including two or more processing devices, such as a central processing unit (CPU), micro processing unit (MPU), and digital signal processor (DSP). It is also possible to implement processing functions of the processor 101 and its programs wholly or partly by an application-specific integrated circuit (ASIC), or programmable logic device (PLD).

The memory 102 serves as the primary storage device in the user terminal 100. Specifically, the memory 102 is used to temporarily store at least some of the operating system (OS) programs and application programs that the processor 101 executes, as well as various types of data to be used by the processor 101 for its processing. For example, the memory 102 may be implemented using a random access memory (RAM) or other volatile semiconductor memory devices.

Other devices on the bus 111 include a storage device 103, a graphics processor 104, a peripheral device interface 105, an input device interface 106, an optical disc drive 107, a peripheral device interface 108, an audio input unit 109, and a network interface 110.

The storage device 103 writes and reads data electrically or magnetically in or on its internal storage medium. The storage device 103 serves as a secondary storage device in the user terminal 100 to store program and data files of the operating system and applications. For example, the storage device 103 can be a hard disk drives (HDD) or solid state drives (SSD).

The graphics processor 104, coupled to a monitor 31, produces video images in accordance with drawing commands from the processor 101 and displays them on a screen of the monitor 31. The monitor 31 may be, for example, an organic electro-luminescence (OEL) display or a liquid crystal display.

The peripheral device interface 105 is coupled to a sensor 32 which is, for example, a time-of-flight (ToF) sensor. The sensor 32 includes a light projector and a light receiver. The sensor 32 causes the light projector to irradiate a plurality of points and then the light receiver to receive reflected light from each of the points. Based on the lapse of time from the irradiation of light to the reception of the reflected light, the sensor 32 measures the distance between the sensor 32 and each of the points. In addition, the sensor 32 detects the presence and position of a human body based on the movement of the human body. The sensor 32 calculates the position of the detected human body relative to the sensor 32 based on the distance between the sensor 32 and a point corresponding to the detected human body, and transmits the calculated relative position to the processor 101 as sensor data.

The input device interface 106 is coupled to a keyboard 33 and a mouse 34, and supplies signals from these devices to the processor 101. The mouse 34 is a pointing device, which may be replaced with other kinds of pointing devices, such as a touchscreen, tablet, touchpad, and trackball.

The optical disc drive 107 reads out data encoded on an optical disc 35, by using laser light. The optical disc 35 is a portable storage medium on which data is recorded in such a manner as to be read by reflection of light. The optical disc 35 may be a digital versatile disc (DVD), DVD-RAM, compact disc read-only memory (CD-ROM), CD-Recordable (CD-R), or CD-Rewritable (CD-RW), for example.

The peripheral device interface 108 is a communication interface used to connect peripheral devices to the user terminal 100. For example, the peripheral device interface 108 may be used to connect a memory device 36 and a memory card reader/writer 37. The memory device 36 is a data storage medium having a capability to communicate with the peripheral device interface 108. The memory card reader/writer 37 is an adapter used to write data to or read data from a memory card 37a, which is a data storage medium in the form of a small card.

The audio input unit 109 is coupled to microphones 38 and 39. The audio input unit 109 converts audio signals input from the microphones 38 and 39 into digital signals and transmits them to the processor 101.

The network interface 110 is connected to a network 20 so as to exchange data with other computers or network devices (not illustrated).

The above-described hardware platform may be used to implement the processing functions of the user terminal 100 according to the second embodiment. The same hardware configuration of the user terminal 100 of FIG. 3 may similarly be applied to the foregoing information processor 10 of the first embodiment. Note that the processor 101 is an example of the processing unit 12 according to the first embodiment. In addition, the memory 102 or the storage device 103 is an example of the storing unit 11 according to the first embodiment. Further, the monitor 31 is an example of the display unit according to the first embodiment.

The user terminal 100 provides various processing functions of the second embodiment by, for example, executing computer programs stored in a computer-readable storage medium. A variety of storage media are available for recording programs to be executed by the user terminal 100. For example, the user terminal 100 may store program files in its own storage device 103. The processor 101 reads out at least part of those programs from the storage device 103, loads them into the memory 102, and executes the loaded programs. Other possible storage locations for the programs include the optical disc 35, the memory device 36, the memory card 37a, and other portable storage media. The programs stored in such a portable storage medium are installed in the storage device 103 under the control of the processor 101, so that they are ready to be executed upon request. It may also be possible for the processor 101 to execute program codes read out of a portable storage medium, without installing them in its local storage devices.

Next described is installation of peripheral devices connected to the user terminal 100.

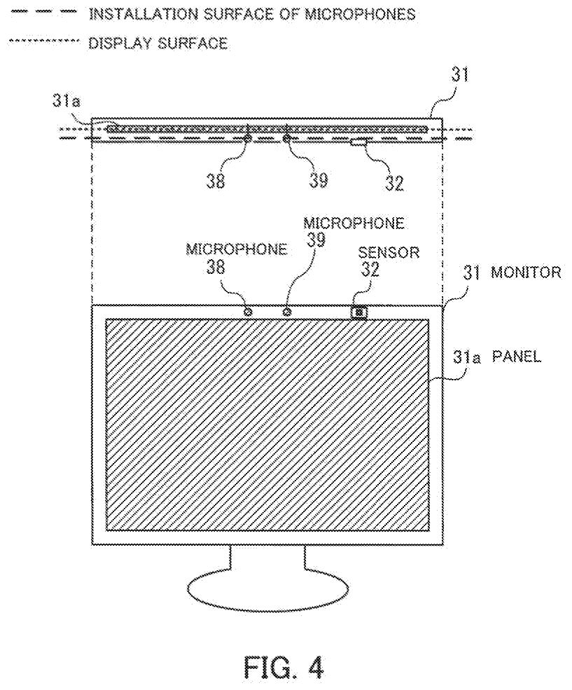

FIG. 4 illustrates an exemplary monitor configuration. The monitor 31 includes a panel 31a, the sensor 32, and the microphones 38 and 39. The panel 31a is a display surface of the monitor 31 and, for example, an organic electro-luminescence (OEL) panel or liquid crystal panel. The panel 31a is installed in the center of the monitor 31.

The sensor 32 is located in the upper part of the monitor 31. The sensor 32 is installed such that the light projector and the light receiver face the front direction of the panel 31a. The microphones 38 and 39 are also located in the upper part of the monitor 31. The microphones 38 and 39 are installed in a plane parallel to the panel 31a (the display surface).

Functions of the user terminal 100 are explained next in detail.

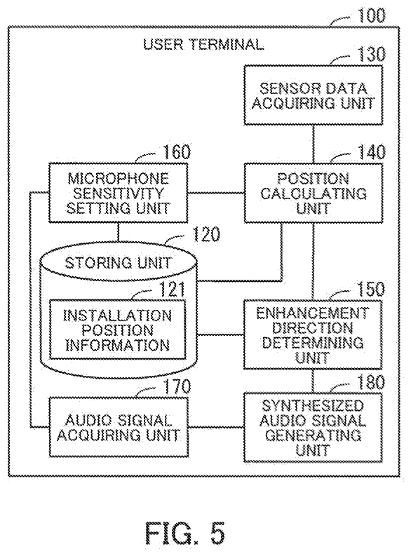

FIG. 5 is a block diagram illustrating exemplary functions of a user terminal. The user terminal 100 includes a storing unit 120, a sensor data acquiring unit 130, a position calculating unit 140, an enhancement direction determining unit 150, a microphone sensitivity setting unit 160, an audio signal acquiring unit 170, and a synthesized audio signal generating unit 180.

The storing unit 120 stores therein installation position information 121, which is information on the installation positions of the sensor 32 and the microphones 38 and 39. The sensor data acquiring unit 130 acquires, from the sensor 32, sensor data which represents relative position coordinates of the user 21 relative to the sensor 32. The position of the user 21 relative to the sensor 32 is an example of the first relative position according to the first embodiment.

The position calculating unit 140 calculates, based on the relative position coordinates of the user 21 relative to the sensor 32, acquired by the sensor data acquiring unit 130, relative position coordinates of the user 21 relative to the midpoint of the microphones 38 and (here termed “reference point”). The position of the user 21 relative to the reference point is an example of the second relative position according to the first embodiment. Specifically, the position calculating unit 140 calculates, with reference to the installation position information 121, relative position coordinates of the sensor 32 relative to the reference point. Then, the position calculating unit 140 adds the relative position coordinates of the user 21 relative to the sensor 32 and the relative position coordinates of the sensor 32 relative to the reference point, to thereby calculate the relative position coordinates of the user 21 relative to the reference point.

The enhancement direction determining unit 150 determines the direction of the user 21 relative to the reference point as a direction in which directionality of beamforming is given (here termed “enhancement direction”). Specifically, based on the relative position coordinates of the user 21 relative to the reference point, calculated by the position calculating unit 140, the enhancement direction determining unit 150 calculates the direction of the user 21 relative to the reference point. Then, the enhancement direction determining unit 150 determines the calculated direction as the enhancement direction.

The microphone sensitivity setting unit 160 sets the sensitivity of the microphones 38 and 39 according to the distance of the user 21. Specifically, the microphone sensitivity setting unit 160 calculates the distance between the user 21 and the reference point based on the relative position coordinates of the user 21 relative to the reference point, calculated by the position calculating unit 140. Then, the microphone sensitivity setting unit 160 sets the microphone sensitivity to high if the calculated distance is greater than or equal to threshold value. The microphone sensitivity is represented by the magnitude of an output voltage to the magnitude of sound pressure applied to each of the microphones 38 and 39, expressed for example in the unit of dB.

For example, in the case where the distance between the user 21 and the reference point is less than 80 cm, the microphone sensitivity setting unit 160 sets the microphone sensitivity to +24 dB. If the distance between the user 21 and the reference point is greater than or equal to 80 cm, the microphone sensitivity setting unit 160 sets the microphone sensitivity to +36 dB.

The audio signal acquiring unit 170 acquires audio signals from the microphones 38 and 39. The synthesized audio signal generating unit 180 generates and enhances, based on the audio signals acquired by the audio signal acquiring unit 170, a synthesized audio signal with the sound coming from the enhancement direction. Specifically, the synthesized audio signal generating unit 180 calculates a difference in the time of arrival of the sound coming from the enhancement direction at the microphones 38 and 39 (here termed “delay time”). The synthesized audio signal generating unit 180 delays the audio signal acquired from one of the microphones 38 and 39 by the delay time, and then combines the delayed audio signal with the audio signal acquired from the other microphone to generate the synthesized audio signal.

It is noted that the solid lines interconnecting functional blocks in FIG. 5 represent some of their communication paths. A person skilled in the art would appreciate that there may be other communication paths in actual implementations. Each functional block seen in FIG. 5 may be implemented as a program module, so that a computer executes the program module to provide its encoded functions.

Next described is beamforming.

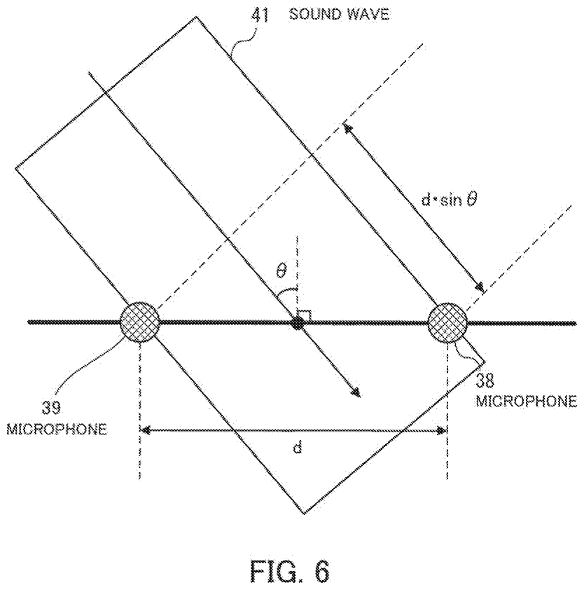

FIG. 6 illustrates exemplary sound transmission. The microphones 38 and 39 are installed with a distance of d between them. In this situation, let us consider the case where a sound wave 41, which is a plane wave of sound, arrives from a direction inclined at an angle of θ (here termed “θ direction”) toward the microphone 39 with respect to a line passing through the midpoint of the microphones 38 and 39 perpendicularly to a straight line connecting the microphones 38 and 39.

In this case, the path of the sound wave 41 to the microphone 39 is shorter than the path to the microphone 38 by d·sin θ. Therefore, a delay time δ between the audio signals generated by converting sound wave 41 obtained by microphone 38 and 39 respectively is calculated by the following equation:

δ=d·sin θ/c (1),

where c is the speed of sound.

Note here that, in beamforming with the 6 direction set as the enhancement direction, the synthesized audio signal generating unit 180 generates a synthesized audio signal by synthesizing the audio signal acquired from the microphone 38 and an audio signal obtained by delaying the audio signal acquired from the microphone 39 by δ. Herewith, the sound coming from the θ direction included in the audio signal obtained by delaying the audio signal acquired from the microphone 39 by δ is in phase with the sound coming from the θ direction included in the audio signal acquired from the microphone 38. As a result, the sound coming from the θ direction is enhanced in the generated synthesized audio signal. On the other hand, sounds coming from directions other than the θ direction included in the audio signal obtained by delaying the audio signal acquired from the microphone 39 by δ are out of phase with sounds coming from the other directions included in the audio signal acquired from the microphone 38. Therefore, the sounds coming from the directions other than the θ direction are not enhanced in the generated synthesized audio signal. With the beamforming technique thus described, the user terminal 100 gives directionality in the θ direction.

Next described is how the sensor 32 identifies the relative position coordinates of the user 21 relative to the sensor 32.

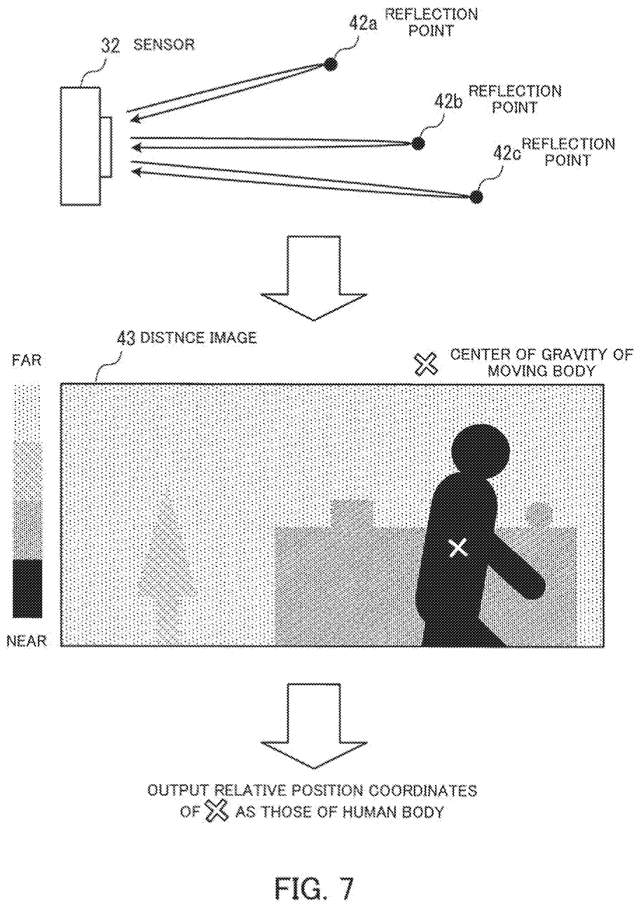

FIG. 7 illustrates an exemplary method of outputting position coordinates of human bodies by a sensor. The sensor 32 detects a moving object (here termed “moving body”) as a human body, and outputs, based on the distance to the detected human body, relative position coordinates of the detected human body relative to the sensor 32.

Using the light projector, the sensor 32 emits light (e.g. near-infrared light) in a plurality of directions. Then, the emitted light is reflected by reflection points 42a, 42b, 42c, and so on. The reflection points 42a, 42b, 42c, and so on represent points on objects (e.g. human body, stationary object, and wall), illuminated by the emitted light. Using the light receiver, the sensor 32 detects reflected light from the reflection points 42a, 42b, 42c, and so on. The sensor 32 calculates the distance to each of the reflection points 42a, 42b, 42c, and so on based on the time from the emission of the light to the detection of the reflected light from each point (here termed “time of flight”), using the following equation: d=c×ToF/2, where d is the distance to the point, c is the speed of light, and ToF is the time of flight.

The sensor 32 may generate a distance image 43 based on the distance to each of the reflection points 42a, 42b, 42c, and so on. Individual pixels in the distance image 43 correspond to the multiple directions of the light emitted. Values of the individual pixels in the distance image 43 represent the distances to the reflection points 42a, 42b, 42c, and so on in the corresponding directions. Note that, in FIG. 7, the magnitude of the individual pixel values in the distance image 43 is represented by the density of dots. In the distance image 43, the darker regions indicate smaller pixel values (i.e., close range) while the lighter regions indicate larger pixel values (long range).

The sensor 32 detects a moving object (here termed “moving body”) based on, for example, changes in each pixel value in the distance image 43. Specifically, the sensor 32 identifies, in the distance image 43, a pixel representing the center of gravity of the detected moving body. The sensor 32 calculates, based on the distance indicated by the value of the identified pixel and the direction corresponding to the identified pixel, relative position coordinates of the center of gravity of the moving body relative to the sensor 32. The sensor 32 outputs the calculated relative position coordinates of the center of gravity of the moving body as relative position coordinates of a human body relative to the sensor 32. Note that, instead of detecting movement of a human body and identifying the pixel representing the center of gravity of the moving body, the sensor 32 may, for example, detect slight movement of a human body resulting from breathing and identify a pixel representing the center of gravity of the region of movement.

Next described is a method of determining the enhancement direction.

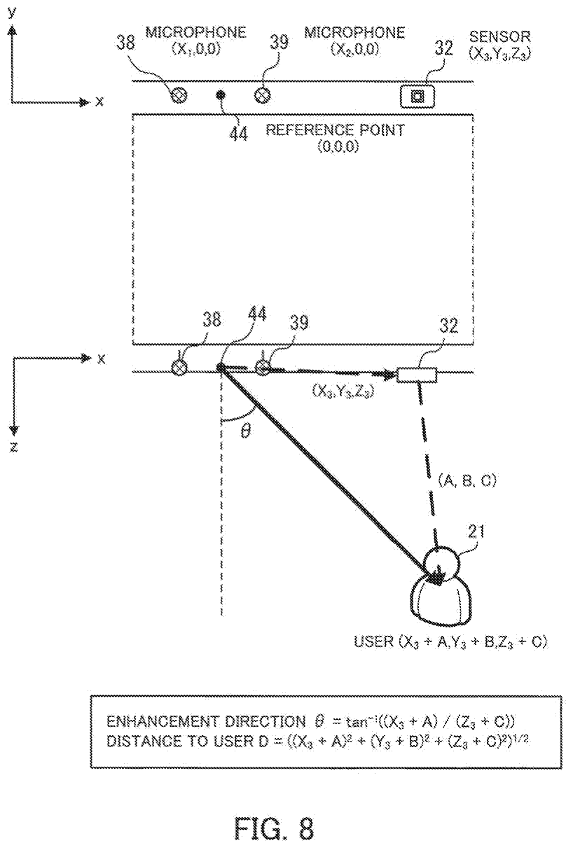

FIG. 8 is an exemplary method of determining the enhancement direction. The enhancement direction is determined based on the position of the user 21 relative to the sensor 32, acquired from the sensor 32, and the installation positions of the sensor 32 and the microphones 38 and 39. An exemplary coordinate system used to represent the installation positions of the sensor 32 and the microphones 38 and 39 is defined as follows.

The x-axis is parallel to a line connecting the microphones 38 and 39. The y-axis is perpendicular to a horizontal plane. The z-axis is perpendicular to the x-y plane. That is, the x-z plane is the horizontal plane. The midpoint of the microphones 38 and 39 is defined as a reference point 44 having position coordinates of (0, 0, 0).

The microphone 38 has position coordinates of (X₁, 0, 0). The microphone 39 has position coordinates of (X₂, 0, 0). The sensor 32 has position coordinates of (X₃, Y₃, Z₃). The sensor 32 outputs relative position coordinates of the user 21 relative to the sensor 32. Assume here that the relative position coordinates of the user 21 relative to the sensor 32, output from the sensor 32, are (A, B, C). In this case, the position coordinates of the user 21 are calculated as (X₃+A, Y₃+B, Z₃+C) by adding the relative position coordinates of the user 21 relative to the sensor 32 to the position coordinates of the sensor 32.

The enhancement direction is defined as the angle θ at which a line connecting the reference point 44 and the user 21 is inclined, in the horizontal plane (the x-z plane), toward the microphone 39 from a line perpendicular to the line connecting the microphones 38 and 39. The angle θ is calculated by:

tan θ=(X₃+A)/(Z₃+C),

θ=tan⁻¹((X₃+A)/(Z₃+C)) (2).

The first equation in Expression (2) gives tan θ based on the position coordinates of the user 21. By multiplying both sides of the first equation in Expression (2) by the inverse function of tan, (tan⁻¹), the angle θ is obtained as the second equation in Expression (2).

The distance d between the microphones 38 and 39 is calculated by:

d=|X₁−X₂| (3).

A distance D between the reference point 44 and the user 21 is calculated by:

D=((X₃+A)²+(Y₃+B)²+(Z₃+C)²)^{1/2} (4).

Note that the distance D is an example of the distance information according to the first embodiment.

Data stored in the storing unit 120 is explained next in detail.

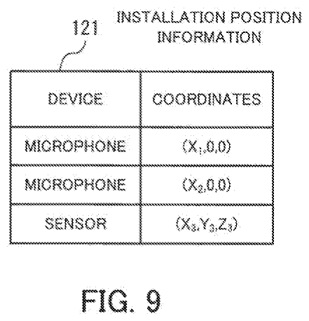

FIG. 9 illustrates exemplary installation position information. Installation position information 121 includes columns of device and coordinates. Each field in the device column contains a device. Each field in the coordinates column contains position coordinates of the corresponding device.

The installation position information 121 registers information on the microphones 38 and 39 and the sensor 32. In the coordinates column, the individual position coordinates in the coordinate system depicted in FIG. 8, for example, are registered for the microphones 38 and 39 and the sensor 32.

Next, a detailed description is given of beamforming procedure used by the user terminal 100.

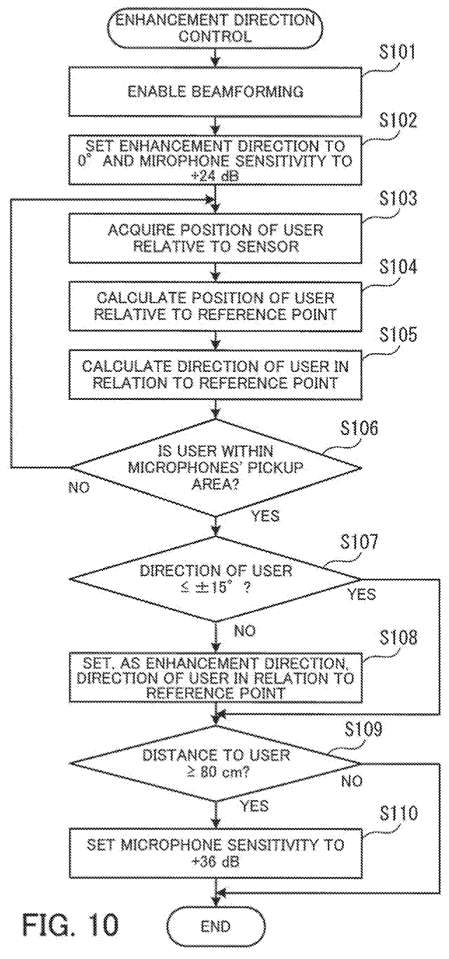

FIG. 10 is a flowchart illustrating exemplary procedure of first enhancement direction control. The process in FIG. 10 is described below in the order of step numbers.

[Step S101] The enhancement direction determining unit 150 enables beamforming.

[Step S102] The enhancement direction determining unit 150 sets the enhancement direction to 0°. In addition, the microphone sensitivity setting unit 160 sets the sensitivity of the microphones 38 and 39 to +24 dB.

[Step S103] The sensor data acquiring unit 130 acquires, from the sensor 32, the position of the user 21 relative to the sensor 32.

[Step S104] Based on the position of the user 21 relative to the sensor 32, acquired in step S103, the position calculating unit 140 calculates the position of the user 21 relative to the reference point 44. For example, the position calculating unit 140 acquires the position of the sensor 32 relative to the reference point 44, by referring to the installation position information 121. Then, the position calculating unit 140 adds the position of the user 21 relative to the sensor 32 and the position of the sensor 32 relative to the reference point 44, to thereby calculate the position of the user 21 relative to the reference point 44.

[Step S105] The enhancement direction determining unit 150 calculates, based on the position of the user 21 relative to the reference point 44, the direction of the user 21 in relation to the reference point 44. For example, the enhancement direction determining unit 150 calculates the angle θ which represents the direction of the user 21 in relation to the reference point 44 by using Expression (2).

[Step S106] The enhancement direction determining unit 150 determines whether the user 21 is within a microphones' pickup area. The microphones' pickup area is a sound pickup coverage of the microphones 38 and 39, which is determined by, for example, the specifications of the microphones 38 and 39 and the shape of the monitor 31 on which the microphones 38 and 39 are installed. The extent of the microphones' pickup area is predetermined, for example, using angles in relation to the reference point 44 and position coordinates relative to the reference point 44. If the enhancement direction determining unit 150 determines that the user 21 is within the microphones' pickup area, the process advances to step S107. If not, the process advances to step S103.

[Step S107] The enhancement direction determining unit 150 determines whether the angle θ representing the direction of the user 21 in relation to the reference point 44 is less than or equal to ±15°. If the enhancement direction determining unit determines that the angle θ is less than or equal to ±15°, the process advances to step S109. If not, the process advances to step S108.

[Step S108] The enhancement direction determining unit 150 determines the direction of the user 21 in relation to the reference point 44, represented by the angle θ, as the enhancement direction.

[Step S109] The microphone sensitivity setting unit 160 determines whether the distance between the user 21 and the reference point 44 is greater than or equal to 80 cm. For example, the microphone sensitivity setting unit 160 calculates the distance between the user 21 and the reference point 44 using Expression (4). Then, the microphone sensitivity setting unit 160 determines whether the calculated distance is greater than or equal to 80 cm. If the microphone sensitivity setting unit 160 determines that the distance between the user 21 and the reference point 44 is greater than or equal to 80 cm, the process advances to step S110. If not, the process ends.

[Step S110] The microphone sensitivity setting unit 160 sets the sensitivity of the microphones 38 and 39 to +36 dB.

As described above, the angle θ of the user 21 in relation to the reference point 44 is calculated from the position of the user 21 relative to the sensor 32, and the direction represented by the angle θ is determined as the enhancement direction. Note here that a difference in the time of arrival of the sound from a sound source to the microphones 38 and 39 (i.e., the “delay time”) is determined by the angle of the sound source in relation to the midpoint of the microphones 38 and 39 (i.e., the reference point 44). The angle θ of the user 21 in relation to the reference point 44 is calculated as the direction of the user 21, which allows accurate calculation of the delay time even when the sensor 32 and the microphones 38 and 39 are installed apart from each other. This in turn facilitates enhancement of the voice of the user 21 by beamforming.

As another way to detect the direction of the user 21, there is a technique to calculate the arrival direction of the voice of the user 21. This technique, however, is not able to determine the enhancement direction until the user 21 starts speaking. On the other hand, the user terminal 100 is able to determine the enhancement direction before the user 21 starts speaking.

In addition, when the distance of the user 21 from the reference point 44 is greater than or equal to a threshold (for example, 80 cm), the microphone sensitivity is set to high (for example, it is changed from +24 dB to +36 dB). This facilitates picking up the voice of the user even when the user 21 is at a distance. Note that cracking sounds may occur when the sound at a close range is picked up with high microphone sensitivity. In view of this, the microphone sensitivity setting unit 160 sets the microphone sensitivity to high when the distance of the user 21 from the reference point 44 is greater than or equal to the threshold.

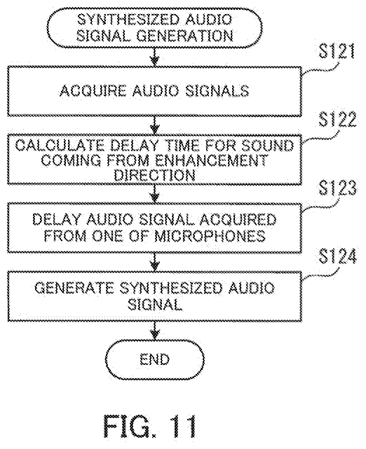

FIG. 11 is a flowchart illustrating exemplary procedure of first synthesized audio signal generation. The process in FIG. 11 is described below in the order of step numbers.

[Step S121] The audio signal acquiring unit 170 acquires audio signals from the microphones 38 and 39.

[Step S122] For the sound coming from the enhancement direction, the synthesized audio signal generating unit 180 calculates the delay time of the audio signal acquired from the microphone 38 with respect to the audio signal acquired from the microphone 39. For example, the synthesized audio signal generating unit 180 calculates the delay time δ using Expression (1).

[Step S123] The synthesized audio signal generating unit 180 delays the audio signal acquired from one of the microphones 38 and 39. For example, the synthesized audio signal generating unit 180 delays the audio signal acquired from the microphone 39 by the delay time δ calculated in step S122.

[Step S124] The synthesized audio signal generating unit 180 generates a synthesized audio signal. For example, the synthesized audio signal generating unit 180 synthesizes the audio signal acquired from the microphone 38 and the audio signal obtained, in step S123, by delaying the audio signal acquired from the microphone 39 by the delay time δ, to thereby generate the synthesized audio signal.

In the above-described manner, the synthesized audio signal is generated, where the sound coming from the enhancement direction is enhanced. Herewith, the voice of the user 21 is enhanced in the synthesized audio signal. The synthesized audio signal provides improved accuracy in speech recognition when used by voice assistant software or the like of the user terminal 100. Note here that the enhancement direction θ is not limited to the front direction (0°). Therefore, the accuracy of speech recognition is improved even if the user 21 is not directly in front of the screen.

### (c) Third Embodiment

Next described is a third embodiment. The third embodiment is directed to setting a direction in which directionality of beamforming is given to a direction of one of a plurality of users.

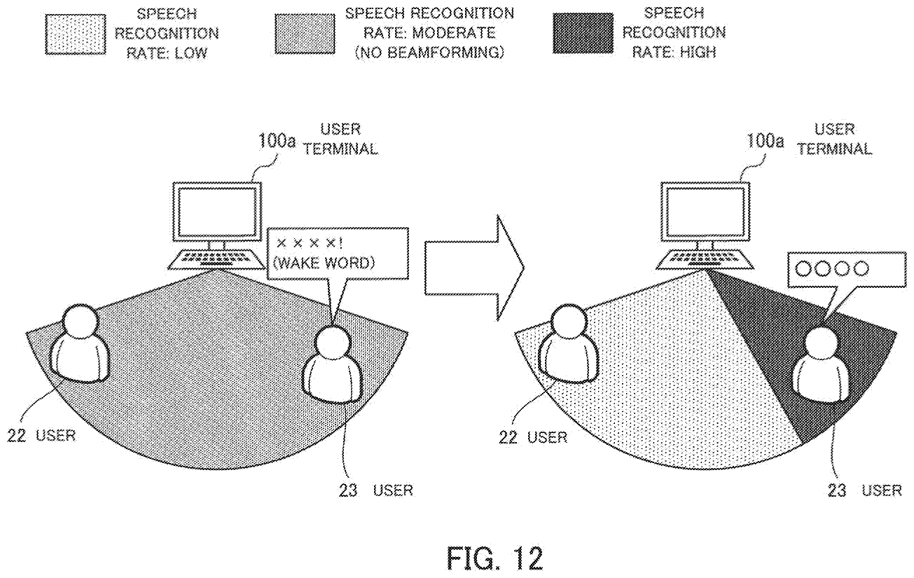

FIG. 12 illustrates an outline of the third embodiment. User terminal 100a is a voice-activated terminal with the use of, for example, voice assistant software. Upon acquiring an audio signal, the user terminal 100a performs processing according to words represented by the acquired audio signal.

Assume here that users 22 and 23 are around the user terminal 100a. The user terminal 100a detects the users 22 and 23 using a sensor, and implements beamforming such that directionality is given, amongst the directions of the users 22 and 23 (a plurality of directions where human bodies are present), in the direction where a user having spoken a predetermined word or phrase (here termed “wake word”) is present. The wake word is a word or phrase used to activate a voice assistant.

For example, when having detected multiple users (the users 22 and 23) around, the user terminal 100a applies no beamforming. This allows the speech recognition rate to be angle independent in all directions (i.e., a moderate speech recognition rate in all directions).

Assume here that the user 23 utters the wake word. Then, the user terminal 100a implements beamforming such that directionality to sound is given in the direction where the user 23 is present. This achieves a high speech recognition rate for the sound coming from the direction of the user 23 while reducing a speech recognition rate for sounds coming from other directions.

The same hardware configuration of the user terminal 100 of FIG. 3 according to the second embodiment is similarly applied to the user terminal 100a. As for the user terminal 100a described below, the same reference numerals are used to refer to corresponding hardware components to those of the user terminal 100.

Functions of the user terminal 100a are explained next in detail.

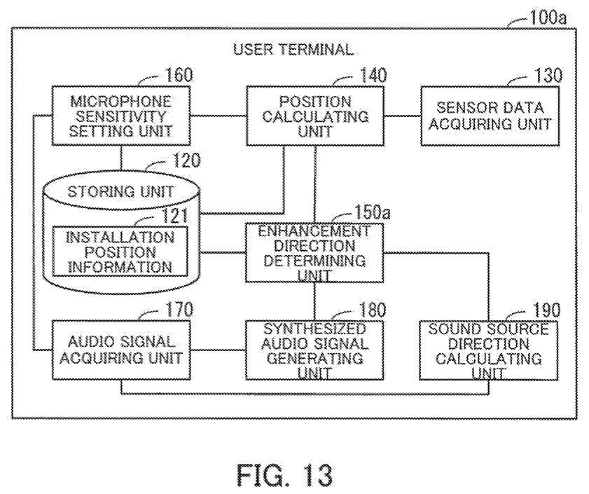

FIG. 13 is a block diagram illustrating another example of functions of a user terminal. The user terminal 100a has an enhancement direction determining unit 150a instead of the enhancement direction determining unit 150. The user terminal 100a further includes a sound source direction calculating unit 190 in addition to the functional components of the user terminal 100.

With respect to each of the users 22 and 23, the enhancement direction determining unit 150a calculates the directions of the users 22 and 23 in relation to the reference point based on relative position coordinates of the users 22 and 23 relative to the reference point. The enhancement direction determining unit 150a determines, as the enhancement direction, a direction closer to the direction of the utterance of the wake word, out of the directions of the users 22 and 23 in relation to the reference point. Note that the direction of the utterance of the wake word is calculated by the sound source direction calculating unit 190 based on the audio signals acquired by the audio signal acquiring unit 170.

Next described is a method used by the sound source direction calculating unit 190 to calculate the direction of the utterance of the wake word.

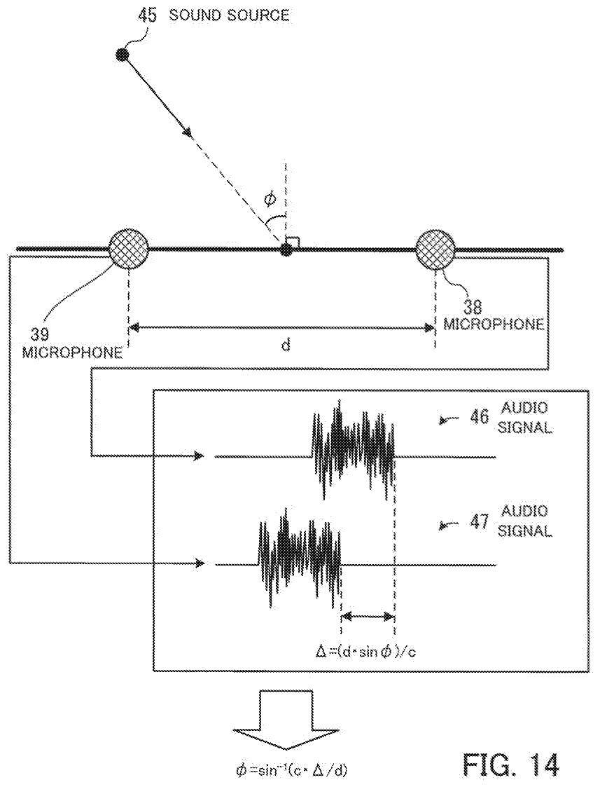

FIG. 14 illustrates an exemplary method of calculating the direction of a sound source. The sound source direction calculating unit 190 calculates the direction of a sound source 45 based on a difference in the time of arrival of the sound from the sound source 45 to the microphones 38 and 39.

The microphones 38 and 39 are installed with a distance of d between them. In this situation, let us consider the case where a plane wave of sound arrives from the sound source 45 in a direction inclined at an angle of φ toward the microphone 39 from a line through the midpoint of the microphones 38 and 39 intersecting perpendicular to a line connecting the microphones 38 and 39 (here termed “φ direction”). The microphone 38 converts the sound from the sound source 45 into an audio signal 46. The microphone 39 converts the sound from the sound source 45 into an audio signal 47.

In this case, a delay time Δ of the audio signal 46 from the audio signal 47 is calculated by plugging in Δ for δ and φ for θ in Expression (1). Therefore, the angle φ is calculated by:

φ=sin⁻¹(c·Δ/d) (5).

The sound source direction calculating unit 190 identifies the delay time Δ of the audio signal 46 from the audio signal 47, associated with the utterance of the wake word. Then, the sound source direction calculating unit 190 calculates the angle φ representing the direction of the sound source 45 using Expression (5). Herewith, the sound source direction calculating unit 190 is able to calculate the direction of the sound source 45 from which the utterance of the wake word came (i.e., the direction where the user having spoken the wake word is present).

Next, a detailed description is given of beamforming procedure used by the user terminal 100a. Note that a synthesized audio signal is generated by the user terminal 100a by the same procedure as in the case of the above-described synthesized audio signal generation by the user terminal 100 according to the second embodiment.

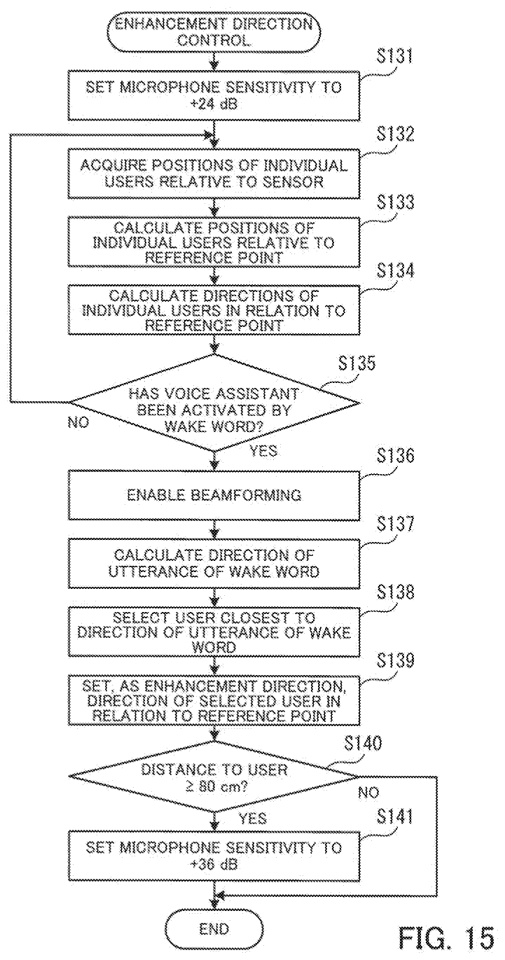

FIG. 15 is a flowchart illustrating exemplary procedure of second enhancement direction control. The process in FIG. 15 is described below in the order of step numbers.

[Step S131] The microphone sensitivity setting unit 160 sets the sensitivity of the microphones 38 and 39 to +24 dB.

[Step S132] The sensor data acquiring unit 130 acquires, from the sensor 32, the positions of the individual users 22 and 23 relative to the sensor 32.

[Step S133] Based on the positions of the individual users 22 and 23 relative to the sensor 32, acquired in step S132, the position calculating unit 140 calculates the positions of the individual users 22 and 23 relative to the reference point 44. For example, the position calculating unit 140 acquires, in reference to the installation position information 121, the position of the sensor 32 relative to the reference point 44. Then, with respect to each of the users 22 and 23, the position calculating unit 140 adds the positions of the users 22 and 23 relative to the sensor 32 and the position of the sensor relative to the reference point 44, respectively, to thereby calculate the positions of the individual users 22 and 23 relative to the reference point 44.

[Step S134] For each of the users 22 and 23, the enhancement direction determining unit 150a calculates, based on the positions of the user 22 and 23 relative to the reference point 44, the directions of the users 22 and 23 in relation to the reference point 44. For example, the enhancement direction determining unit 150a calculates, using Expression (2), angles θ₁ and θ₂ which represent the directions of the users 22 and 23, respectively, in relation to the reference point 44.

[Step S135] The enhancement direction determining unit 150a determines whether the voice assistant has been activated by the wake word. If the enhancement direction determining unit 150a determines that the voice assistant has been activated by the wake word, the process advances to step S136. If not, the process advances to step S132.

[Step S136] The enhancement direction determining unit 150a enables beamforming.

[Step S137] The sound source direction calculating unit 190 calculates the direction of the utterance of the wake word. For example, the sound source direction calculating unit 190 obtains, from the audio signal acquiring unit 170, audio signals of the wake word acquired from the individual microphones 38 and 39 and identifies the delay time Δ. Then, the sound source direction calculating unit 190 calculates, using Expression (5), the angle φ which represents the direction of the utterance of the wake word.

[Step S138] The enhancement direction determining unit 150a selects, between the users 22 and 23, a user closer to the direction of the utterance of the wake word. For example, the enhancement direction determining unit 150a selects a user corresponding to, between the angles θ₁ and θ₂, one having a smaller difference from the angle φ (e.g. the user 23 corresponding to the angle θ₂).

[Step S139] The enhancement direction determining unit 150a determines the direction of the user selected in step S138 in relation to the reference point 44 as the enhancement direction. For example, the enhancement direction determining unit 150a determines the direction of the user 23 in relation to the reference point 44, represented by the angle θ₂, as the enhancement direction.

[Step S140] The microphone sensitivity setting unit 160 determines whether the distance between the user 23 and the reference point 44 is greater than or equal to 80 cm. For example, the microphone sensitivity setting unit 160 calculates the distance between the user 23 and the reference point 44 using Expression (4). Then, the microphone sensitivity setting unit 160 determines whether the calculated distance is greater than or equal to 80 cm or not. If the microphone sensitivity setting unit 160 determines that the distance between the user 23 and the reference point 44 is greater than or equal to 80 cm, the process advances to step S141. If not, the process ends.

[Step S141] The microphone sensitivity setting unit 160 sets the sensitivity of the microphones 38 and 39 to +36 dB.

As described above, in the presence of a plurality of users, the direction of the user who said the wake word is determined as the enhancement direction. That is, the direction of the user attempting to use the voice assistant of the user terminal 100a is determined as the enhancement direction. This allows the voice assistant of the user terminal 100a to achieve improved accuracy in speech recognition even if multiple users are present.

It may be considered reasonable to set, as the enhancement direction, the angle φ calculated by the sound source direction calculating unit 190 assuming that the angle φ represents the direction of the user having said the wake word. However, if the number of microphones and their available installation positions are limited, the angle φ may be calculated with less accuracy. In view of this, amongst a plurality of angles calculated based on the position coordinates of the multiple users, acquired from the sensor 32, one closest to the angle φ is selected. This yields better accuracy in setting the enhancement direction compared to setting the direction of the sound source calculated based on the audio signals as the enhancement direction.

### (d) Fourth Embodiment

The fourth embodiment is directed to setting directions in each of which directionality of beamforming is given according to positions of a plurality of users.

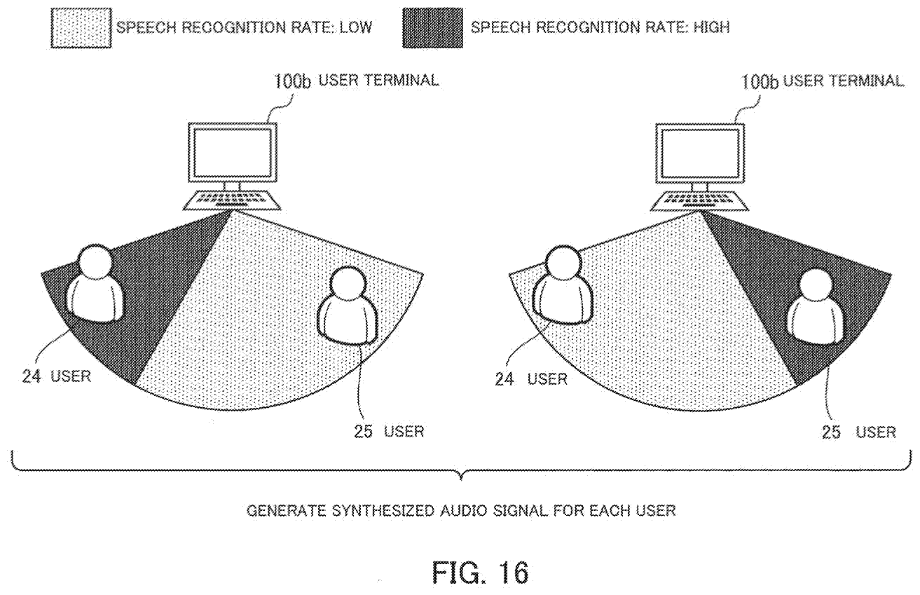

FIG. 16 illustrates an outline of the fourth embodiment. A user terminal 100b is a voice-activated terminal with the use of, for example, voice assistant software. Upon acquiring an audio signal, the user terminal 100b performs processing according to words represented by the acquired audio signal.

Users 24 and 25 operate the user terminal 100b by voice. The user terminal 100b detects the users 24 and 25 using a sensor, and generates synthesized audio signals by implementing beamforming such that directionality is given in directions where the individual users 24 and 25 are present (a plurality of directions where human bodies are present). In the case of implementing beamforming such that directionality to sound is given in the direction of the user 24, a high speech recognition rate for the sound coming from the direction of the user 24 is obtained while reducing a speech recognition rate for sounds coming from other directions. Similarly, in the case of implementing beamforming such that directionality to sound is given in the direction of the user 25, a high speech recognition rate for the sound coming from the direction of the user 25 is obtained while reducing a speech recognition rate for sounds coming from other directions.

The same hardware configuration of the user terminal 100 of FIG. 3 according to the second embodiment is similarly applied to the user terminal 100b. In addition, the user terminal 100b has the same functional components as the user terminal 100 of FIG. 5. As for the user terminal 100b described below, the same reference numerals are used to refer to corresponding hardware and functional components to those of the user terminal 100.

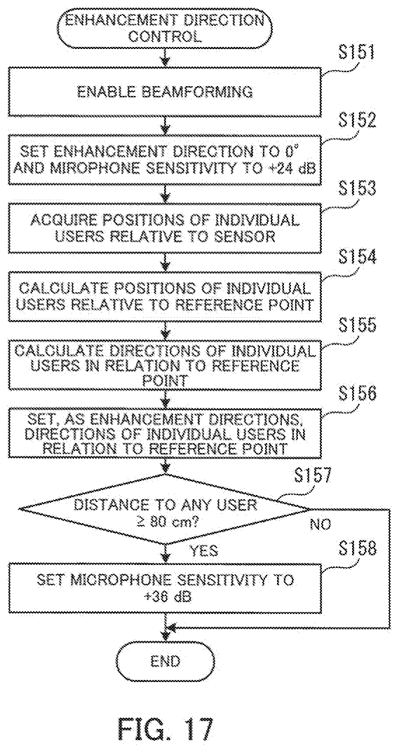

FIG. 17 is a flowchart illustrating exemplary procedure of third enhancement direction control. The process in FIG. 17 is described below in the order of step numbers.

[Step S151] The enhancement direction determining unit 150 enables beamforming.

[Step S152] The enhancement direction determining unit 150 sets the enhancement direction to 0°. In addition, the microphone sensitivity setting unit 160 sets the sensitivity of the microphones 38 and 39 to +24 dB.

[Step S153] The sensor data acquiring unit 130 acquires, from the sensor 32, the positions of the individual users 24 and 25 relative to the sensor 32.

[Step S154] Based on the positions of the individual users 24 and 25 relative to the sensor 32, acquired in step S153, the position calculating unit 140 calculates the positions of the individual users 24 and 25 relative to the reference point 44. For example, the position calculating unit 140 acquires, in reference to the installation position information 121, the position of the sensor 32 relative to the reference point 44. Then, with respect to each of the users 24 and 25, the position calculating unit 140 adds the positions of the users 24 and 25 relative to the sensor 32 and the position of the sensor 32 relative to the reference point 44, respectively, to thereby calculate the positions of the individual users 24 and 25 relative to the reference point 44.

[Step S155] For each of the users 24 and 25, the enhancement direction determining unit 150 calculates, based on the positions of the users 24 and 25 relative to the reference point 44, the directions of the users 24 and 25 in relation to the reference point 44. For example, the enhancement direction determining unit 150 calculates, using Expression (2), the angles θₐ and θ_{b} which represent the directions of the users 24 and 25, respectively, in relation to the reference point 44.

[Step S156] The enhancement direction determining unit 150 determines the directions of the individual users 24 and 25 in relation to the reference point 44, represented by the angles θₐ and θ_{b}, respectively, as the enhancement directions.

[Step S157] The microphone sensitivity setting unit 160 determines whether the distance between any of the users 24 and 25 and the reference point 44 is greater than or equal to 80 cm. For example, the microphone sensitivity setting unit 160 calculates the distance between the reference point 44 and each of the users 24 and 25 using Expression (4). Then, the microphone sensitivity setting unit 160 determines whether the calculated distance is greater than or equal to 80 cm or not. If the microphone sensitivity setting unit 160 determines that the distance between any of the users 24 and 25 and the reference point 44 is greater than or equal to 80 cm, the process advances to step S158. If not, the process ends.

[Step S158] The microphone sensitivity setting unit 160 sets the sensitivity of the microphones 38 and 39 to +36 dB.

As described above, the directions of the individual users are determined as the enhancement directions. In addition, the microphone sensitivity is set to high if the distance between any of the users and the reference point 44 is greater than or equal to the threshold. This facilitates picking up the voice of the user at a distance.

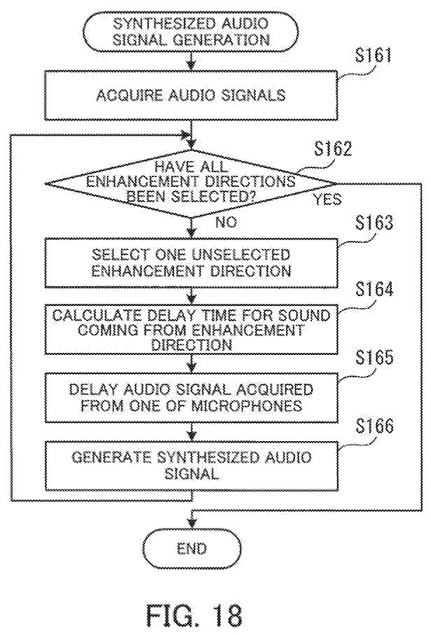

FIG. 18 is a flowchart illustrating exemplary procedure of second synthesized audio signal generation. The process in FIG. 18 is described below in the order of step numbers.

[Step S161] The audio signal acquiring unit 170 acquires audio signals from the microphones 38 and 39.

[Step S162] The synthesized audio signal generating unit 180 determines whether to have selected all the enhancement directions. If the synthesized audio signal generating unit 180 determines that all the enhancement directions have been selected, the process ends. If the synthesized audio signal generating unit 180 determines that there are one or more unselected enhancement directions, the process advances to step S163.

[Step S163] The synthesized audio signal generating unit 180 selects an unselected enhancement direction.

[Step S164] For the sound coming from the enhancement direction selected in step S163, the synthesized audio signal generating unit 180 calculates the delay time of the audio signal acquired from the microphone 38 with respect to the audio signal acquired from the microphone 39. For example, the synthesized audio signal generating unit 180 calculates the delay time δ using Expression (1).

[Step S165] The synthesized audio signal generating unit 180 delays the audio signal acquired from one of the microphones 38 and 39. For example, the synthesized audio signal generating unit 180 delays the audio signal acquired from the microphone 39 by the delay time δ calculated in step S164.

[Step S166] The synthesized audio signal generating unit 180 generates a synthesized audio signal. For example, the synthesized audio signal generating unit 180 synthesizes the audio signal acquired from the microphone 38 and the audio signal obtained, in step S165, by delaying the audio signal acquired from the microphone 39 by the delay time δ, to thereby generate the synthesized audio signal. Then, the process advances to step S162.

In the above-described manner, a plurality of synthesized audio signals is generated, in each of which the sound coming from one of a plurality of enhancement directions is enhanced. Herewith, the voice of the user providing an audio input is enhanced in one of the synthesized audio signals. As a result, when voice assistant software or the like of the user terminal 100b performs speech recognition processing on each of the generated synthesized audio signals, one or another synthesized audio signal provides improved accuracy in speech recognition.

### (e) Another Embodiment

According to the second embodiment, the voice assistant software or the like of the user terminal 100 handles processing based on the synthesized audio signal; however, a server may engage in the processing based on the synthesized audio signal.

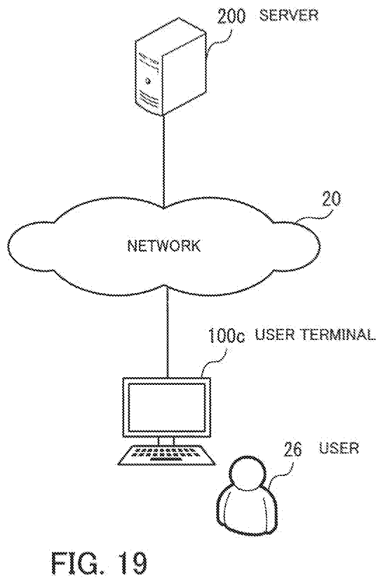

FIG. 19 illustrates an exemplary system configuration according to another embodiment. A user terminal 100c detects a user 26 using a sensor, and implements beamforming such that directionality is given in the direction where the user 26 is present. The user terminal 100c is connected to a server 200 via the network 20. The user terminal 100c transmits a synthesized audio signal generated by beamforming to the server 200.

The server 200 performs processing based on the synthesized audio signal acquired from the user terminal 100c. For example, the server 200 analyzes the synthesized audio signal and transmits words represented by the synthesized audio signal to the user terminal 100c.

According to an aspect, it is possible to improve accuracy in speech recognition.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a plurality of microphones configured to convert sound into audio signals;
a sensor configured to detect presence and position of one or more human bodies and output sensor data representing one or more directions in which the one or more human bodies are present; and
a processor configured to execute a process including:
determining an enhancement direction based on the one or more directions indicated by the sensor data acquired from the sensor, and
generating a synthesized audio signal where sound coming from the enhancement direction is enhanced, based on the audio signals acquired from the plurality of microphones.

2. The information processing apparatus according to claim 1, wherein:
the sensor data includes one or more first relative positions indicating positions of the one or more human bodies relative to the sensor, and
the process further includes:
calculating, based on installation positions of the plurality of microphones, an installation position of the sensor, and the one or more first relative positions, one or more second relative positions indicating positions of the one or more human bodies relative to a predetermined reference point defined based on the installation positions of the plurality of microphones, and
calculating, as the one or more directions, directions from the predetermined reference point to the one or more second relative positions.

3. The information processing apparatus according to claim 1, wherein the process further includes determining, as the enhancement direction, one of the one or more directions.

4. The information processing apparatus according to claim 3, wherein:
the process further includes:
acquiring a direction of utterance of a predetermined word or phrase, and
determining one of the plurality of directions which is closest to the direction of utterance of the predetermined word or phrase as the enhancement direction among the plurality of directions represented by the sensor data.

5. The information processing apparatus according to claim 1, wherein:
the process further includes:
determining each of the plurality of directions represented by the sensor data as the enhancement direction, and
generating a plurality of synthesized audio signals in each of which sound coming from the corresponding enhancement direction is enhanced.

6. The information processing apparatus according to claim 1, wherein:
the sensor data includes distance information indicating distances between each of the one or more human bodies and the sensor, and
the process further includes increasing sensitivity of the plurality of microphones when any of the distances is greater than or equal to a threshold.

7. The information processing apparatus according to claim 1, further comprising:
a display unit,
wherein the plurality of microphones is installed in a plane parallel to a display surface of the display unit.

8. A non-transitory computer-readable recording medium storing therein a computer program that causes a computer to execute a process comprising:
determining an enhancement direction based on sensor data output from a sensor for detecting presence and position of one or more human bodies, the sensor data representing one or more directions in which the one or more human bodies are present; and
generating a synthesized audio signal where sound coming from the enhancement direction is enhanced, based on a plurality of audio signals acquired from a plurality of microphones.
